(19) United States
(12) Patent Application Publication
(10) Pub. No.: US 2025/0084962 A1
(43) Pub. Date: Mar. 13, 2025

(54) RECEPTACLE FOR CRYOGENIC COUPLING AND ASSEMBLY COMPRISING SUCH A RECEPTACLE

(71) Applicant: L'Air Liquide, Societe Anonyme pour l'Etude et l’Exploitation des Procedes Georges Claude, Paris (FR)

(72) Inventor: Gaetan COLEIRO, Sassenage (FR)

(73) Assignee: L'Air Liquide, Societe Anonyme pour l'Etude et l’Exploitation des Procedes Georges Claude, Paris (FR)

(21) Appl. No.: 18/825,552

(22) Filed: Sep. 5, 2024

(30) Foreign Application Priority Data
Sep. 7, 2023 (FR) FR 2309431

(51) Int. Cl. F17C 13/00

(52) U.S. Cl. CPC F17C 13/001; F17C 2203/0375; F17C 2203/0391; F17C 2205/0173; F17C 2205/0335; F17C 2205/037; F17C 2205/0394; F17C 2250/0439

(57) ABSTRACT

The invention relates to a receptacle for receiving a cryogenic coupling for filling between two uses, the receptacle comprising a tubular sleeve which has an inlet and a bottom and delimits a tubular housing configured to accommodate a coupling of cylindrical overall shape, characterized in that the tubular sleeve is thermally insulated, and in that the bottom is situated above the inlet thereof in a use configuration such that the terminal end of the coupling is held there oriented upwards in a position stowed in the receptacle.

### CROSS REFERENCE TO RELATED APPLICATIONS

This application claims the benefit of priority under 35 U.S.C. § 119 (a) and (b) to French patent application No. FR2309431, filed Sep. 7, 2023, which is herein incorporated by reference in its entirety.

### FIELD OF THE INVENTION

The invention relates to a receptacle for receiving a cryogenic coupling and to an assembly comprising such a receptacle and a cryogenic coupling.

### BACKGROUND OF THE INVENTION

The invention relates more particularly to a receptacle for receiving a cryogenic coupling for filling between two uses, the receptacle comprising a tubular sleeve which has an inlet and a bottom and delimits a tubular housing configured to accommodate a coupling of cylindrical overall shape in an airtight manner.

To shorten the durations of phases for connecting and disconnecting hoses for transferring cryogenic fluids (LNG, LH2, etc.), use is made of couplings (or nozzles) of the quick connect type.

These technologies enable self-closing of the end of the coupling, which reduces the need for purging and heating with respect to conventional couplings of the “Johnston” type.

This technology notably enables cold disconnection of the coupling. After the disconnection, the coupling is cold, thus generally causing a deposition of ice (see the condensation of air around the coupling in the case of hydrogen). This ice has to be discharged to prevent this water from becoming lodged in the dead volumes of the coupling (this possibly producing a leak or an accumulation of ice as the hose is used).

If the duration between two filling operations is too long (notably overnight), the inputs of heat on the hose require the hose to be heated in order to limit the increase in pressure. This entails having to cool the hose again before the next use. This prolongs the durations of fluid transfers.

In certain configurations, shortening the durations of filling operations is a key issue.

In the majority of fuel filling stations, the hoses are provided with couplings or pistols with receptacles for stowing between the different filling operations.

For cold or cryogenic fluids, it is known to clean the couplings following their use to remove the ice deposits that form. This may notably be effected directly in the receptacle by blowing of dry air when said receptacle is stowed.

Documents WO21093985A1, FR3104671A1 and US20180354778A1 describe receptacles for cryogenic couplings, but they do not completely meet the requirements of use.

The need for heating/drying before each filling operation therefore becomes crucial for avoiding ice deposits.

### SUMMARY OF THE INVENTION

An aim of the present invention is to overcome all or some of the aforementioned drawbacks of the prior art.

To this end, the receptacle according to certain embodiments of the invention, which is otherwise in accordance with the generic definition thereof given in the above preamble, is essentially characterized in that the receptacle further comprises a drying module provided with removable attachment member(s) at the end of the tubular sleeve delimiting the bottom, that is to say that the drying module can be disposed in a first position attached at the end of the sleeve and a second position detached from the sleeve, the drying module comprising a circulation channel for circulating a flow of drying gas, the bottom of the sleeve comprising an intake valve configured to be connected with the circulation channel when the drying module is in its first position and to admit a flow of drying gas into the sleeve, the receptacle having an assembly of seal(s) configured to cooperate with the coupling and to isolate the internal volume of the sleeve from the exterior of the sleeve.

Moreover, embodiments of the invention may have one or more of the following features:
the intake valve is a check valve,
the sleeve comprises a discharge valve configured to discharge any overpressure in the sleeve, the discharge valve being, for example, a check valve,
the drying module comprises a heating member, for example a resistor and a source of pressurized drying gas or an end intended to be connected to a source of heated pressurized drying gas,
the tubular sleeve is thermally insulated, for example with a double-wall structure that is vacuum insulated between the walls,
the receptacle has a locking mechanism configured to cooperate with the coupling and to provide removable blocking of the coupling in the sleeve,
the receptacle has a detector for detecting the presence of the coupling in the sleeve and/or a temperature sensor in the sleeve,
the receptacle has a system for evacuating the internal volume of the sleeve.

The invention also relates to an assembly comprising a fluid transfer line provided with a fluidic coupling and a receptacle according to any one of the features above or below, comprising an assembly of O-ring seal(s) disposed at the inlet of the sleeve and/or on the coupling.

The invention may also relate to any alternative device or method comprising any combination of the features above or below within the scope of the claims.

Further particular features and advantages will become apparent upon reading the following description, which is provided with reference to the figures.

### BRIEF DESCRIPTION OF THE DRAWINGS

The invention will be understood better from reading the following description and from studying the accompanying figures. These figures are given only by way of illustration and do not in any way limit the invention.

FIG. 1 is a schematic view in section of a receptacle according to a possible embodiment of the invention in a first configuration.

FIG. 2 is a schematic view in section of the aforementioned receptacle in a second configuration.

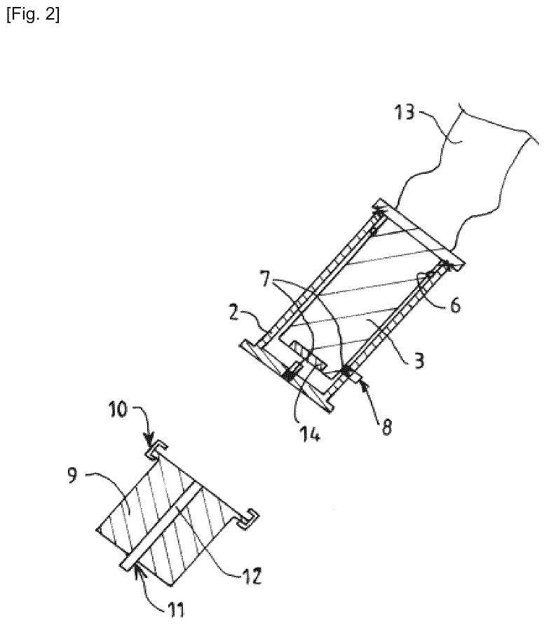

FIG. 3 is a schematic view in section of the aforementioned receptacle in a third configuration.

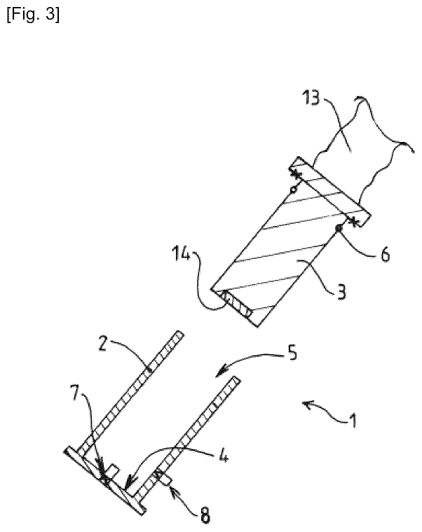

### DETAILED DESCRIPTION OF THE INVENTION

Throughout the figures, the same reference signs relate to the same elements.

In this detailed description, the following embodiments are examples. Although the description refers to one or more embodiments, this does not mean that the features apply only to a single embodiment. Individual features of different embodiments may also be combined and/or interchanged in order to provide other embodiments.

The receptacle 1 illustrated is configured to receive a cryogenic coupling 3 for filling between two uses. Such a coupling 3 (sometimes called nozzle or pistol) has, for example, a cylindrical overall shape and is situated at an end of a flexible pipe 13 for transferring cryogenic fluid. This coupling 3 has at least one valve 14, notably a self-closing valve which is shown schematically.

The receptacle 1 comprises a body in the form of a tubular sleeve 2. This sleeve has an inlet 5 and a bottom 4 and delimits a tubular housing configured to accommodate the coupling 3.

The sleeve 2 is formed of preferably thermally insulated walls.

The bottom 4 may be situated above the inlet 5 thereof in a use configuration such that the terminal end of the coupling 3 is held there oriented upwards in a position stored in the receptacle 1.

The receptacle 1 further comprises a drying module 9 provided with removable attachment member(s) 10 at the end of the tubular sleeve 2 delimiting the bottom 4, that is to say that the drying module 9 may be disposed in a first position attached at the end of the sleeve 2 and a second position detached from the sleeve 2. For example, the attachment member(s) 10 may comprise a hook system and/or a system of attachment by elastic deformation.

The drying module 9 comprises a circulation channel 12 for circulating a flow of drying gas, which opens out at an end of the drying module 9.

The drying module 9 comprises, for example, a heating member, for example a resistor and a source of pressurized drying gas or an end intended to be connected to a source of, preferably heated, pressurized drying gas.

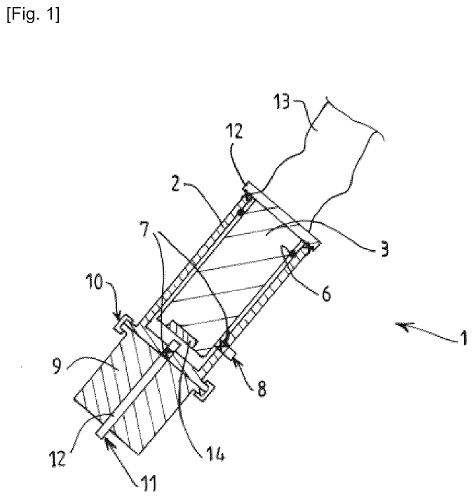

The bottom 4 of the sleeve 2 comprises an intake valve 7 configured to be connected with the circulation channel 12 when the drying module 9 is in its first position and to admit a flow of drying gas into the sleeve 2 (cf. [FIG. 1]).

As illustrated, the sleeve 2 also preferably comprises a discharge valve 8 configured to discharge any overpressure in the sleeve 2.

The intake valve 7 and/or the discharge valve 8 may be a check valve, for example a valve which opens depending on the pressure differential to which its ends are subjected.

The architecture proposed notably makes it possible to heat/dry the coupling 3 but also to keep it isolated from the external environment during its movements. This tends to minimize the ice and therefore the probabilities of the seals leaking.

The receptacle has a heating/drying means and a sleeve 2 forming a removable airtight cover that makes it possible to keep the coupling isolated and protected from the external environment during movement phases.

The drying module 9 makes it possible to heat and/or dry the coupling 3 in the sleeve 2.

This drying may be ensured by circulation of dry gas (air or nitrogen, for example). The sleeve 2 makes it possible to isolate the coupling 3 from the external environment. This sleeve may be mechanically connected to the drying module 9 so as to allow the coupling 3 to be heated.

This sleeve 2 is preferably airtight, like its mechanical connection with the coupling 3.

The assembly of sleeve 2 and drying module 9 may be oriented in such a way as to facilitate the discharge of water but also to ensure that the droplets and crystals blown during the de-icing do not accumulate in the vicinity of the valve 14 of the coupling.

For example, the sleeve 2 may be oriented according to any orientation, but the preferred orientations would be 60° to 30° (end with the bottom 4 pointing downwards) and −30° to −90° (end with the bottom 4 pointing upwards).

Equally, the inlet 7 and outlet 8 for the drying gas may be placed in such a way as to optimize the heating/drying.

One example of use may have all or some of the steps below.

After the coupling has been used (filling of a tank, for example), the coupling 3 is separated from the filled tank.

The sleeve 2 is put onto the coupling 3 (or the coupling is introduced into the sleeve 2). The sleeve 2 is mechanically connected to the coupling 3 in an airtight manner. This is preferably effected with a level of tightness, determined with respect to the external environment, in order to ensure isolation with regard to moisture.

The assembly comprising the coupling 3 and the sleeve 2 can be moved towards the drying module 9 (or vice versa) whilst being protected from the external environment.

The assembly comprising the coupling 3 and the sleeve 2 is mechanically connected to the drying module 9.

After potential mechanical locking 10 between the sleeve 2 and the drying module 9, drying gas can be circulated in order to sweep the coupling 3 in the sleeve 2. This makes it possible to discharge the ice that has been deposited. The triggering of this sweeping may be triggered manually and/or by the detection of the connection and/or after the coupling 3 has been cooled, that is to say before the next filling operation (or after).

This sweeping with gas may be provided for a predetermined duration, for example between 2 and 120 min and/or as a function of a reached, measured, predetermined temperature threshold (for example between zero and −70° C.). A temperature probe may be installed in the sleeve 2 to determine the end of the de-icing (and the initiation of the application a vacuum, where appropriate).

When the scanning with gas is interrupted, the coupling 3 is ready for the next filling operation.

Before the next filling operation, the coupling 3, provided with its sleeve 2, can be separated from the drying module 9 and moved towards the tank to be filled whilst being protected from the external environment (via the sleeve 2). During this step, the coupling 3 and the sleeve 2 remain secured to one another but are separated from the drying module 9.

In the vicinity of the tank to be filled, the sleeve 2 can be removed from the coupling 3 and the coupling 3 can be connected to the tank to be filled.

The drying gas may be nitrogen, dry air, helium or any other suitable gas or mixture.

This drying gas may be preheated to accelerate the drying (in the module 9 or upstream). The heating may be effected by conduction and/or circulation of gas.

It would be possible to envisage making the heating mode and the sleeve 2 integral.

The sleeve may be placed under vacuum.

The sleeve 2 may have a double-wall structure with thermal insulation. The thermal insulation comprises a vacuum (with multi-layer insulation and/or foams, silica, etc.) or is without a vacuum (foams, glass fibre, etc.). This inter-wall space may or may not communicate with the internal space of the sleeve 2. In the event of communication, this can allow the two volumes to be jointly placed under vacuum during use.

The outer face of the inner wall of the double wall (surface facing the inter-wall space) may be coated with a coating or a particular surface condition having a reflection coefficient that limits the inputs of heat by radiation.

The detection of the coupling 3 in the sleeve 2 may be effected optically and/or mechanically and/or inductively.

It is possible to provide a collector for facilitating the management and the discharge of the water recovered at the bottom of the sleeve 2.

Thus, the receptacle has a sleeve 2 forming a removable, preferably airtight cover which minimizes the ice and therefore the probabilities of the valve 14 seals leaking or ice entering the lines/tank. This sleeve may be mechanically detachable from the drying module 9.

The invention is particularly advantageous for use in stations for filling liquid hydrogen tanks (cars, lorries, planes, ships) in order to minimize the time between two successive filling operations and in order to limit the leaks due to ice.

The structure is particularly advantageous for the filling installations (of the ship type) where the distance to be covered is relatively great between the receptacle of the station and the tank to be filled.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A receptacle for receiving a cryogenic coupling for filling between two uses, the receptacle comprising:
a tubular sleeve which has an inlet and a bottom and delimits a tubular housing configured to accommodate a coupling of cylindrical overall shape in an airtight manner, and
a drying module provided with removable attachment member(s) at the end of the tubular sleeve delimiting the bottom, that is to say the drying module can be disposed in a first position attached at the end of the sleeve and a second position detached from the sleeve, the drying module comprising a circulation channel for circulating a flow of drying gas,
wherein the bottom of the tubular sleeve comprises an intake valve configured to be connected with the circulation channel when the drying module is in its first position and to admit a flow of drying gas into the sleeve,
wherein the receptacle has an assembly of seal(s) configured to cooperate with the coupling and to isolate the internal volume of the sleeve from the exterior of the sleeve.

2. The receptacle according to claim 1, wherein the intake valve is a check valve.

3. The receptacle according to claim 1, wherein the sleeve comprises a discharge valve configured to discharge any overpressure in the sleeve, the discharge valve being, for example, a check valve.

4. The receptacle according to claim 1, wherein the drying module comprises a heating member, for example a resistor and a source of pressurized drying gas or an end intended to be connected to a source of heated pressurized drying gas.

5. The receptacle according to claim 1, wherein the tubular sleeve is thermally insulated, for example with a double-wall structure that is vacuum insulated between the walls.

6. The receptacle according to claim 1, further comprising a locking mechanism configured to cooperate with the coupling and to provide removable blocking of the coupling in the sleeve.

7. The receptacle according to claim 1, further comprising a detector configured to detect the presence of the coupling in the sleeve and/or a temperature sensor in the sleeve.

8. The receptacle according to claim 1, further comprising a system for placing the internal volume of the sleeve under vacuum.

9. An assembly comprising a fluid transfer line provided with a fluidic coupling and a receptacle according to claim 1, further comprising an assembly of O-ring seal(s) disposed at the inlet of the sleeve and/or on the coupling.
